(19) United States
(12) Patent Application Publication
(10) Pub. No.: US 2026/0294167 A1
(43) Pub. Date: Oct. 1, 2026

(54) Tree Trivet

(71) Applicant: Dropsmart LLC, Palm City, FL (US)

(72) Inventor: Spencer Stevens, Palm City, FL (US)

(21) Appl. No.: 19/096,814

(22) Filed: Apr. 1, 2025

(51) Int. Cl. A47J 36/34; A47G 23/03

(52) U.S. Cl. CPC A47J 36/34; A47G 23/0316

(57) ABSTRACT

An embodiment of the present invention is a tree trivet comprising: a stand, wherein the stand comprises a base and a rod extending upwards from the base; a plurality of tree members, wherein: the tree members comprise a plurality of slats extending radially from a central opening; the tree members are configured to removably stack on the rod of the stand; and the tree members are configured to switch between a flat configuration wherein the slats are coplanar with the central opening and a sloped configuration wherein the slats extend diagonally downward from the central opening.

### BACKGROUND

Patent disclosures related to trivets are known in the prior art patent literature.

For example, US20170265680A1 relates to a collapsible trivet comprising a first support section, a second support section and a connecting member, the first support section including two support arms and being pivotally mounted to one end of the connecting member, and the second support section being pivotally mounted to the other end of the connecting member, the trivet being positionable to an open position in which the first and second support members and the connecting member lie substantially flat in the same plane for allowing a dish to be placed across the trivet.

The trivet is advantageous because it can serve a dual use. When collapsed, the trivet is substantially flat, and can be used to place a hot pan or dish on a tabletop, the trivet protecting the tabletop from heat and water damage. In the open position (e.g., a first open position), each of the first and second support members may support a pan or other object, protecting the surface from heat and moisture.

The first and second support members may also together support a single large pan or dish, eliminating the need for multiple trivets, or large and non-foldable trivets. When the support members are pivoted into a second open position, the second support member may rest on the tabletop and a pan lid may be supported upside-down on the first support section. The handle of the pan lid may pass between the two support arms.

In this way, a pan lid can be stored whilst a cook is, for example, stirring or inspecting the contents of the corresponding pan. The pan lid is suspended from the surface so that the surface is not damaged. The pan lid is also upside-down so that condensate does not drip from the lid onto the work surface, and the underside is not in contact with any surface, which is advantageous for preserving food hygiene. When the pan lid is required again, the cook can reach underneath the first support section and grasp the handle of the pan lid, before sliding the pan lid off the first support section between the two support arms.

However, prior art trivets are lacking in ease of use and versatility among other limitations.

### SUMMARY OF INVENTION

Therefore, the present invention provides an improved trivet in the form of a tree trivet.

An embodiment of the present invention provides a tree trivet comprising: a stand, wherein the stand comprises a base and a rod extending upwards from the base; a plurality of tree members, wherein: the tree members comprise a plurality of slats extending radially from a central opening; the tree members are configured to removably stack on the rod of the stand; and the tree members are configured to switch between a flat configuration wherein the slats are coplanar with the central opening and a sloped configuration wherein the slats extend diagonally downward from the central opening.

### BRIEF DESCRIPTION OF THE DRAWINGS

FIG. 1 is a top view of the Tree Trivet in a folded configuration;

FIG. 2 is a front view thereof which is a mirror image of the back view;

FIG. 3 is a left side view thereof which is a mirror image of the right side view;

FIG. 4 is a top view thereof;

FIG. 5 is a bottom view thereof;

FIG. 6 is a front perspective view thereof in an unfolded configuration;

FIG. 7 is a back perspective view thereof in an unfolded configuration.

### DETAILED DESCRIPTION

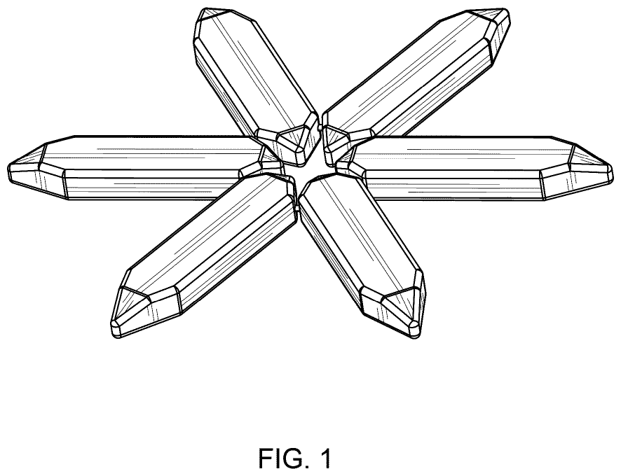

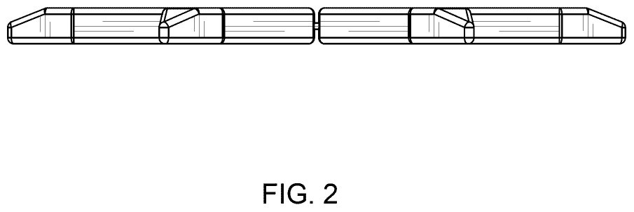

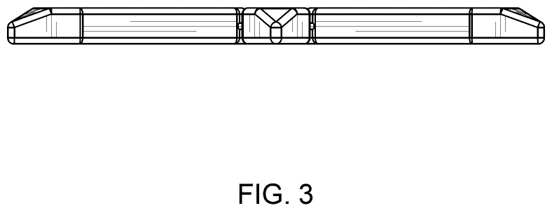

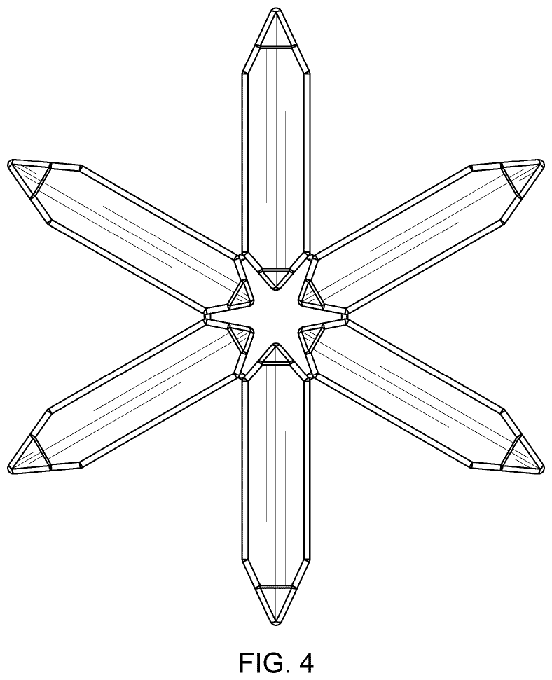

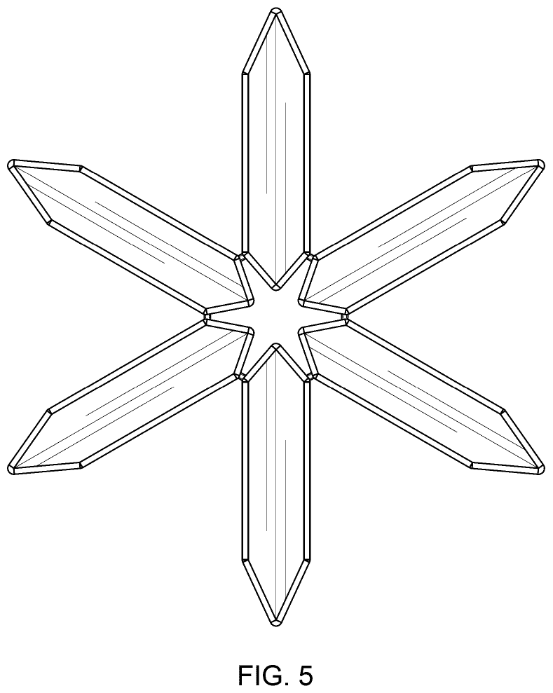

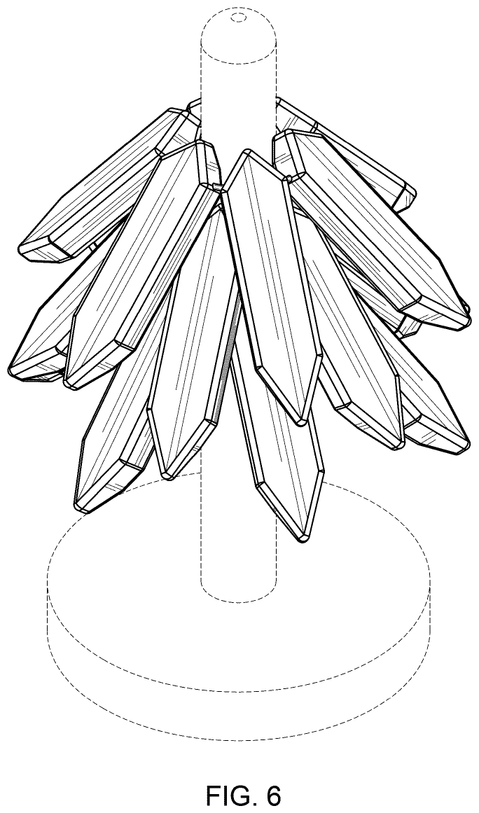

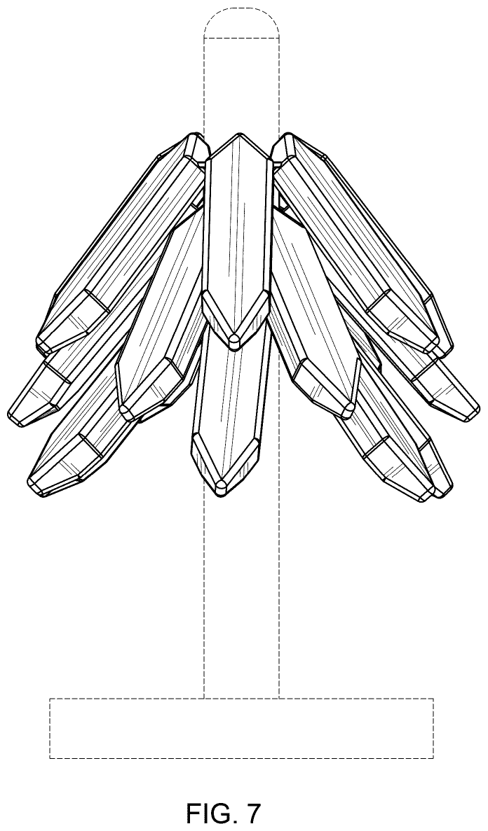

FIG. 1-7 illustrate the tree trivet according an embodiment of the present invention.

The tree stands about 9″ tall. The tree comprises a base, a stand in the form of a cylindrical rod, and tree members comprising leaves which are configured to stack on the stand.

The tree members are arranged in leaves about 8″ in extent and are configured removably so that they can be removed from the stand. The stand has a notch so that the tree members when placed on the stand are held in place.

The leaves comprise a plurality of slats extending radially from a central opening. The slats extend diagonally downward from the central opening to form an approximately 45 degree angle with the vertical plane of the central opening.

When the tree members are removed from the stand, they are configured to switch between a downward-sloping configuration and a flat configuration, atop of which an object can be placed.

All of the components of the base, stand, and tree members can be fashioned from e.g., Walnut wood which has heat and stain resistant properties.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A tree trivet comprising:
a stand, wherein the stand comprises a base and a rod extending upwards from the base;
a plurality of tree members, wherein:
the tree members comprise a plurality of slats extending radially from a central opening;
the tree members are configured to removably stack on the rod of the stand; and
the tree members are configured to switch between a flat configuration wherein the slats are coplanar with the central opening and a sloped configuration wherein the slats extend diagonally downward from the central opening.
